(19) United States
(12) Patent Application Publication
(10) Pub. No.: US 2026/0077586 A1
(43) Pub. Date: Mar. 19, 2026

(54) LIQUID EJECTION HEAD AND LIQUID EJECTION APPARATUS

(71) Applicant: CANON KABUSHIKI KAISHA, Tokyo (JP)

(72) Inventors: TOSHIO NEGISHI, Kanagawa (JP); YOSHIYUKI NAKAGAWA, Kanagawa (JP); TAKASHI KATO, Kanagawa (JP)

(21) Appl. No.: 19/325,885

(22) Filed: Sep. 11, 2025

(30) Foreign Application Priority Data
Sep. 13, 2024 (JP) 2024-159087

(51) Int. Cl. B41J 2/045; B41J 2/14; B41J 2/16

(52) U.S. Cl. CPC B41J 2/04541; B41J 2/04543; B41J 2/04573; B41J 2/0458; B41J 2/1601; B41J 2002/14491; B41J 2202/12

(57) ABSTRACT

A liquid ejection head includes: an ejection module which includes an ejection driver element and an ejection heater capable of being electrically connected to the ejection driver element; a circulation module which includes a circulation driver element and a circulation heater capable of being electrically connected to the circulation driver element; and a controller which controls each of the ejection driver element and the circulation driver element into any one of a conduction state and a non-conduction state. The controller makes an ejection drive frequency utilized to drive the ejection driver element and a circulation drive frequency utilized to drive the circulation driver element different from each other.

### BACKGROUND

### Field of the Technology

The present disclosure relates to a liquid ejection head and a liquid ejection apparatus which eject a liquid while circulating the liquid.

### Description of the Related Art

Of circulation-type liquid ejection apparatuses which circulate a liquid (also referred to as an ink), one in which an ink in a circulation flow passage is circulated by a circulation driver element different from an ejection driver element for ejecting the ink in the circulation flow passage communicating with ejection orifices has conventionally been known. In addition, International Publication No. WO2018/190872 (hereinafter, referred to as Document 1) discloses a technology of selectively driving an ejection driver element and a circulation driver element.

### SUMMARY

A liquid ejection head according to one aspect of the present disclosure comprises: an ejection module which includes an ejection driver element and an ejection heater capable of being electrically connected to the ejection driver element; a circulation module which is arranged in a pair with the ejection module, and which includes a circulation driver element and a circulation heater capable of being electrically connected to the circulation driver element; and a control unit which controls each of the ejection driver element and the circulation driver element into any one of a conduction state and a non-conduction state, wherein the control unit makes an ejection drive frequency utilized to drive the ejection driver element and a circulation drive frequency utilized to drive the circulation driver element different from each other.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view schematically showing a liquid ejection apparatus provided with a main ink tank as a liquid reservoir unit outside a liquid ejection head.

FIG. 1B is a perspective view schematically showing the liquid ejection apparatus provided with an ink sub tank directly above the liquid ejection head.

FIG. 2A is an exploded perspective view of the liquid ejection head of FIG. 1.

FIG. 2B is a diagram showing an example configured with one ejection element board for four colors.

FIG. 2C is a diagram showing an example configured with one ejection element board for two colors.

FIG. 2D is a diagram showing an example configured with one ejection element board for one color.

FIG. 3 is a diagram showing an example of a circuit configuration of an ejection element board of a first use case.

FIG. 4 is a diagram showing an example of a circuit configuration of the circulation group control circuit of FIG. 3.

FIG. 5 is a timing chart of the ejection element board of FIG. 3.

FIG. 6 is a diagram showing an example of a circuit configuration of an ejection element board of a second use case.

FIG. 7 is a timing chart of the ejection element board of FIG. 6.

FIG. 8 is a plan view of an ejection element board.

FIG. 9 is a plan view of an ejection element board.

FIG. 10 is a plan view of an ejection element board.

FIG. 11 is a plan view of an ejection element board.

### DESCRIPTION OF THE EMBODIMENTS

Hereinafter, preferred embodiments of the present invention will be described in detail with reference to the attached drawings. Note that the following embodiments are not intended to limit the matters of the present disclosure, and all the combinations of features described in the following embodiments are not necessarily essential for the solution of the present disclosure. Note that the same constituent elements are denoted by the same reference signs.

### Overview

A circulation-type liquid ejection apparatus which circulates an ink has conventionally been known. This liquid ejection apparatus includes a liquid ejection head. The ink is circulated for the purpose of discharging bubbles in flow passages of this liquid ejection head and suppressing the thickening of the ink near discharge ports. For the circulation of the ink, for example, a system using a difference in pressure (hereinafter, also referred to as a “differential pressure system”) is well-known. In the differential pressure system, a pressure on the side to supply the ink to ejection orifices (also referred to as the in side) is set to be higher than a pressure on the side to recover the ink (also referred to as the out side) by using a pressure adjustment mechanism or the like. Setting a difference in pressure in this way makes it possible for the ink to flow from the in side toward the out side. Here, in order to circulate the ink, it is necessary to return the ink which has flowed to the out side to the in side. For this reason, a pump is required as a mechanism. Note that there is a configuration in which an ink is circulated between a liquid ejection head and a liquid ejection apparatus main body by providing a pump outside the head of the liquid ejection apparatus main body. Alternatively, there is also a configuration in which an ink in a liquid ejection head is circulated by providing a pump inside the liquid ejection head. However, such a circulation method of a differential pressure system requires mechanisms such as a pressure adjustment mechanism and a pump. Hence, the sizes of the liquid ejection apparatus main body and a liquid ejection head tend to be increased.

In view of this, as a method for circulating an ink other than a differential pressure system, there is also a method described below. Specifically, there is a method in which a circulation driver element which is different from an ejection driver element for ejecting an ink is disposed in a circulation flow passage which communicates with ejection orifices. A mechanism for circulating an ink in a circulation flow passage by driving a circulation driver element with such an arrangement configuration is also known.

In addition, a circuit configuration for selectively driving each of a plurality of ejection driver elements and a plurality of circulation driver elements which are provided in an ejection element board included in a liquid ejection head is also disclosed. In such a circuit configuration, a function for selectively driving each of the plurality of ejection driver elements and the plurality of circulation driver elements by allocating an address to each of the plurality of ejection driver elements and the plurality of circulation driver elements is achieved. Hence, as the number of the plurality of ejection driver elements and the plurality of circulation driver elements increases, a transfer data amount of data signals for individually designating addresses increases. As the transfer data amount increases, circuits for dealing with a problem such as a crosstalk of data signals increases, for example. For this reason, it is preferable not to increase the transfer data amount. In view of this, in order to reduce the transfer data amount, it can be considered to employ a configuration of converting selection information on a circulation driver element in an ejection element board in accordance with selection information on an ejection driver element to select each circulation driver element. According to such a configuration, it is possible to reduce the transfer data amount. However, even in such a configuration, each of the ejection driver elements and the circulation driver elements is selected in accordance with a data signal having the same drive frequency. In the first place, an optimal timing for ejecting an ink and an optimal timing for circulating the ink are different. Hence, there is a case where even if the same drive frequency is an optimal drive frequency for the ejection driver elements, the same drive frequency is not an optimal drive frequency for the circulation driver elements. Therefore, in the present disclosure, at least an ejection drive frequency utilized to drive ejection driver elements and a circulation drive frequency utilized to drive circulation driver elements are made different from each other. According to such processing, the circulation drive frequency can be set to a drive frequency different from the ejection drive frequency, so that the circulation driver elements can be driven at an optimal drive frequency.

### <Liquid Ejection Apparatus 50>

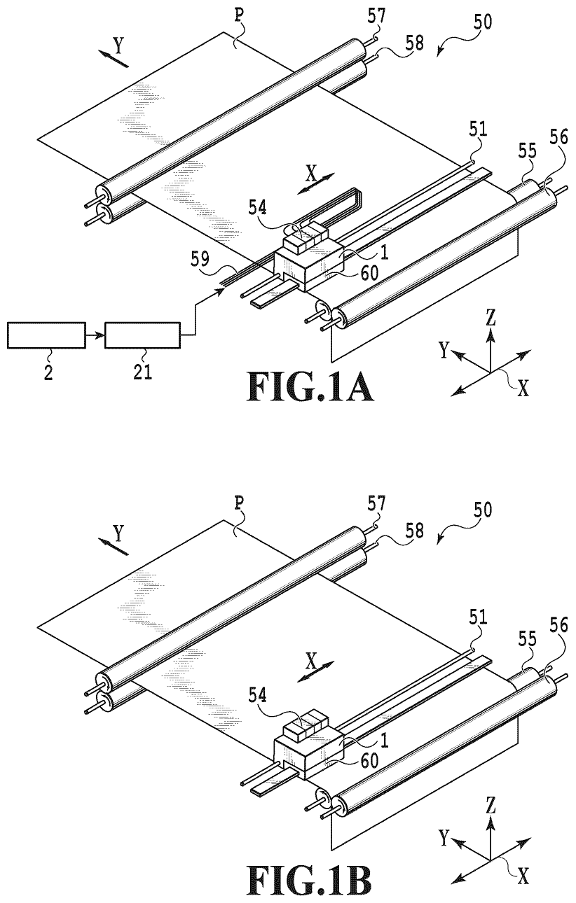

FIGS. 1A and 1B is diagrams showing an example of an overall configuration of a liquid ejection apparatus 50. FIG. 1A is a perspective view schematically showing the liquid ejection apparatus 50 provided with a main ink tank 2 as a liquid reservoir unit outside a liquid ejection head 1. FIG. 1B is a perspective view schematically showing the liquid ejection apparatus 50 provided with an ink sub tank 54 directly above the liquid ejection head 1. First, portions common to FIG. 1A and FIG. 1B will be described.

The liquid ejection apparatus 50 includes the liquid ejection head 1 and conveyance rollers 55, 56, 57, and 58. The liquid ejection head 1 is capable of scanning in a direction X which intersects a conveyance direction Y of an ejection-target medium P. The liquid ejection head 1 is mounted on a carriage 60. The carriage 60 reciprocates in a main scanning direction (also referred to as the direction X) along a guide shaft 51. The conveyance rollers 55, 56, 57, and 58 convey the ejection-target medium P in a sub scanning direction (also referred to as the conveyance direction Y) which intersects the main scanning direction (orthogonal thereto in the present embodiment). That is, the liquid ejection apparatus 50 is configured as a serial-type inkjet liquid ejection apparatus which ejects a liquid from the liquid ejection head 1 onto the ejection-target medium P which is being conveyed in the conveyance direction Y while causing the liquid ejection head 1 to scan in the direction X. Note that the application of the present disclosure is not limited to a serial-type inkjet liquid ejection apparatus. It is also possible to apply the present disclosure to a page wide-type inkjet liquid ejection apparatus which ejects a liquid onto the ejection-target medium P which is being conveyed in the conveyance direction Y by using a line head (page wide-type head) which is long in a page-width direction of the ejection-target medium P. Note that in FIG. 1A and FIG. 1B, a direction Z indicates the vertical direction. That is, the direction Z is a direction which intersects an X-Y plane specified by the direction X and the conveyance direction Y (orthogonal thereto in the present embodiment).

The liquid ejection head 1 is capable of ejecting inks of four types of black (K), cyan (C), magenta (M), and yellow (Y). The liquid ejection head 1 is capable of printing a full-color image by using these four types of inks. Note that the inks which can be ejected from the liquid ejection head 1 are not limited to the above-described four types of inks. For example, the present disclosure can also be applied to a liquid ejection head 1 for ejecting inks of other types such as particular color inks. That is, the types and the number of inks to be ejected from the liquid ejection head 1 are not limited.

Next, portions different between FIG. 1A and FIG. 1B will be described. In FIG. 1A, the ink sub tank 54 is mounted on the liquid ejection head 1. To the ink sub tank 54, four ink supply tubes (liquid communication passages) 59 are attached. In addition, the liquid ejection apparatus 50 includes the ink tank 2 and an external pump 21. The ink tank 2 stores the inks. The inks stored in the ink tank 2 are supplied to the ink sub tank 54 via the four ink supply tubes 59 by a drive force of the external pump 21. On the other hand, in FIG. 1B, the ink sub tank 54 is provided directly above the liquid ejection head 1. In FIG. 1B, the points different from FIG. 1A are that since the ink tank 2 is not provided outside the liquid ejection head 1, the four ink supply tubes 59 are also not attached, and the external pump 21 is also not provided. Note that in both of FIG. 1A and FIG. 1B, the liquid ejection head 1 may be provided integrally with the ink sub tank 54, and configured to be capable of being detached from or attached to the carriage 60. Alternatively, the ink sub tank 54 may be provided integrally with the carriage 60, such that only the ink sub tank 54 is configured to be capable of being detached or attached. The following description will be made by using the configuration of FIG. 1A.

### <Liquid Ejection Head 1>

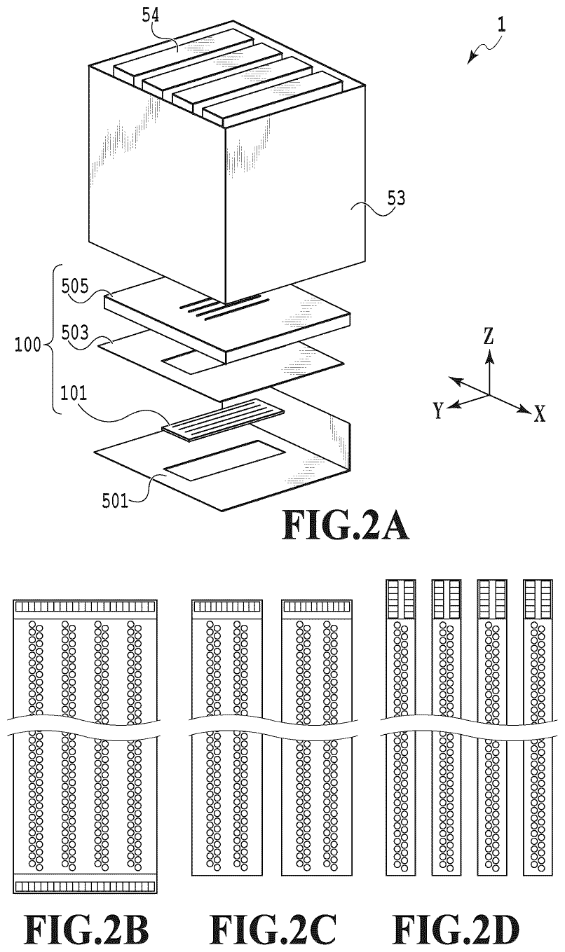

FIG. 2 is a diagram showing an example of a basic configuration of the liquid ejection head 1 of FIG. 1. FIG. 2A is an exploded perspective view of the liquid ejection head 1 of FIG. 1. FIG. 2B, FIG. 2C, and FIG. 2D are overall views of an ejection element board 101 of FIG. 2A. The liquid ejection head 1 includes a housing unit 53, the ink sub tank 54, and an ejection element unit 100. The ink sub tank 54 is housed in the housing unit 53. The ejection element unit 100 is provided on a bottom portion of the housing unit 53. Note that although not shown in the drawings, four joints which are connected to the respective four ink supply tubes 59 corresponding to the four types of inks are provided on a wall surface of the housing unit 53. That is, an individual ink supply passage is provided for each type of ink.

The ejection element unit 100 includes a first support member 505, a second support member 503, the ejection element board 101, and an electrical wiring member 501. The first support member 505 is provided with ink supply ports and ink recovery ports. The second support member 503 is provided with an opening. The ejection element board 101 is bonded and fixed to the first support member 505. The first support member 505 is bonded and fixed to the second support member 503. The second support member 503 holds the electrical wiring member 501 such that the electrical wiring member 501 is electrically connected to the ejection element board 101. The electrical wiring member 501 applies electrical signals for ejecting the inks and electrical signals for circulating the inks to the ejection element board 101. The details of the electrical signals for ejecting the inks and the electrical signals for circulating the inks will be described later.

FIG. 2B shows an example configured with one ejection element board 101 for four colors. The four colors are, for example, black, cyan, magenta, and yellow, and arrays are separated for the respective colors. The arrays are each configured along the conveyance direction Y, and are arranged at intervals along the direction X. A plurality of ejection orifices included in each array are arranged at equal intervals along the direction Y. Note that the ejection orifices of each array may be arranged side by side in one array along the direction Y at no intervals in the direction X. In addition, only black may be arranged in two arrays such that five arrays in total are arranged for four colors including black and the other three colors. FIG. 2C shows an example configured with one ejection element board 101 for two colors. Two ejection element boards 101 may be mounted in one liquid ejection head 1. Alternatively, two liquid ejection heads 1 in each of which one ejection element board 101 is mounted may be prepared. FIG. 2D shows an example configured with one ejection element board 101 for one color. Four ejection element boards 101 may be mounted in one liquid ejection head 1. Alternatively, four liquid ejection heads 1 in each of which one ejection element board 101 is mounted may be prepared. Note that in the case where the ejection element board 101 is divided into a plurality of ejection element boards 101 as shown in FIG. 2C and FIG. 2D, all the ejection element boards 101 do not have to have the same length. In addition, various other combinations of the numbers of colors for the ejection element boards 101 are possible, and the same applied to the case where the total number of colors is larger than four. Hereinafter, the details of the electrical signals for ejecting the inks and the electrical signals for circulating the inks will be described with reference to each use case of circuit configuration and the like.

### First Use Case

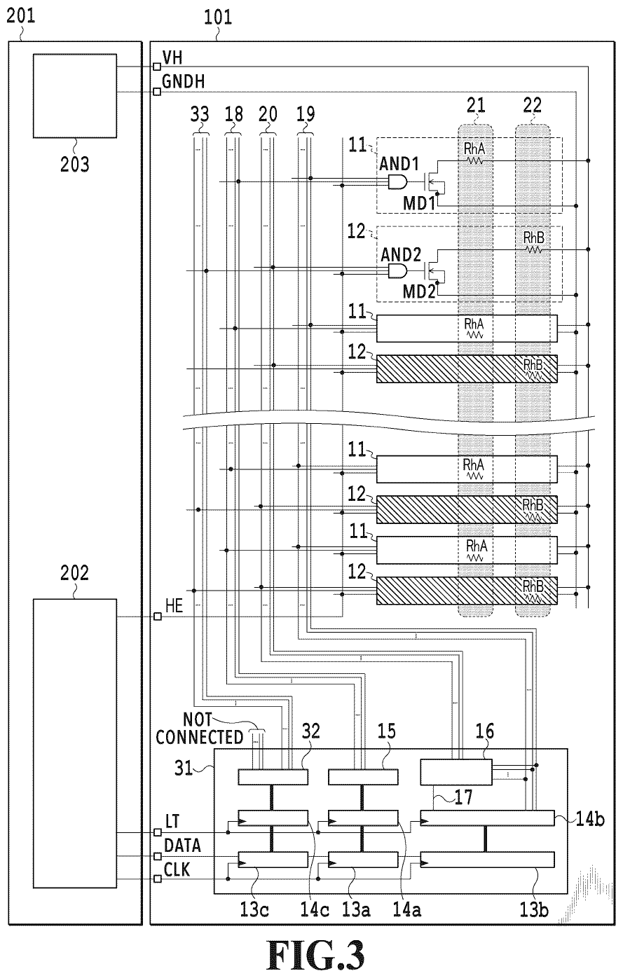

FIG. 3 is a diagram showing an example of a circuit configuration of an ejection element board 101 of a first use case. The ejection element board 101 is supplied with various signals from a main board 201. The main board 201 includes a controller 202 and a power supply circuit 203. The controller 202 is configured mainly with a ROM, a RAM, and a CPU, and controls the liquid ejection head 1 by supplying various electrical signals to the ejection element board 101. The controller 202 supplies each of an enable signal HE, a latch signal LT, a data signal DATA, and a clock signal CLK to the ejection element board 101. The detail of each signal will be described later. In addition, the power supply circuit 203 applies a power supply voltage VH to the ejection element board 101. The power supply circuit 203 and the ejection element board 101 are connected by GNDH. The GNDH functions as a ground potential.

### Overview of Wirings

The ejection element board 101 includes a plurality of ejection modules 11, a plurality of circulation modules 12, and a control data supply circuit 31. The circulation modules 12 are arranged in a pair with the ejection modules 11, respectively. Hence, the number of the circulation modules 12 is equal to the number of the ejection modules 11. Between the plurality of ejection modules 11 and the control data supply circuit 31, an ejection group selection signal wiring 19, a circulation group selection signal wiring 20, an ejection time-division selection signal wiring 18, and a circulation time-division selection signal wiring 33 are routed. Between the plurality of circulation modules 12 and the control data supply circuit 31 as well, an ejection group selection signal wiring 19, a circulation group selection signal wiring 20, an ejection time-division selection signal wiring 18, and a circulation time-division selection signal wiring 33 are routed.

### Ejection Module 11

The ejection module 11 includes an ejection heater RhA, an ejection driver element MD1, and an ejection logic circuit AND1. The ejection heater RhA is configured with, for example, an electrothermal conversion element. The ejection heater RhA is in the state where the voltage is applied from the power supply voltage VH to the ejection heater RhA, and a current flows through the ejection heater RhA if the ejection driver element MD1 is in a conduction state. The ejection driver element MD1 is configured with, for example, a MOSFET (Metal-Oxide-Semiconductor Field Effect Transistor). Note that the ejection driver element MD1 may be configured with a component other than a MOSFET. For example, the ejection driver element MD1 may be configured with a bipolar transistor. Alternatively, the ejection driver element MD1 may be configured with an IGBT (Insulated Gate Bipolar Transistor). The ejection logic circuit AND1 selectively drives the ejection driver element MD1. The enable signal HE, an ejection group selection signal, and an ejection time-division selection signal are inputted into the input side of the ejection logic circuit AND1. The enable signal HE is transmitted from the controller 202. The enable signal HE controls a current pulse width of the ejection driver element MD1, that is, a time during which the conduction state is established between the drain and the source of the ejection driver element MD1 to allow the current to continuously flow between the drain and the source of the ejection driver element MD1. The enable signal HE is a signal for adjusting the current pulse width so that a more desirable thermal energy can be generated in consideration of various manufacturing variations. The various manufacturing variations include, for example, a manufacturing variation of resistance values of the ejection heaters RhA mounted in the ejection element board 101, and a manufacturing variation of the power supply circuit 203. In addition, the various manufacturing variations also include a voltage drop of a power supply-side wiring in the case of simultaneously driving a plurality of heaters such as the ejection heater RhA and a circulation heater RhB. Note that the heaters to be simultaneously driven are the ejection heater RhA and the circulation heater RhB which is arranged at a position which is not in pair with this ejection heater RhA. The enable signal HE may be transmitted from the controller 202 via an external input terminal provided on the ejection element board 101, which is not shown. The ejection group selection signal is supplied from the ejection group selection signal wiring 19. The ejection time-division selection signal is supplied from the ejection time-division selection signal wiring 18. The output side of the ejection logic circuit AND1 is connected to the gate of the ejection driver element MD1. Hence, the ejection driver element MD1 is configured such that if all the signals inputted from the input side of the ejection logic circuit AND1 are 1, the voltage is applied to the gate of the ejection driver element MD1, so that the conduction state is established between the drain and the source of the ejection driver element MD1. If the conduction state has been established between the drain and the source of the ejection driver element MD1, the current flows through the ejection heater RhA, so that heat is generated in the ejection heater RhA. By this series of operations, bubbles are generated in the ink, and the ink is ejected, making it possible to conduct ejection onto the ejection-target medium P. Note that although an example in which the ejection heater RhA is configured with an electrothermal conversion element has been described, the ejection heater RhA is not particularly limited to this. For example, the ejection heater RhA may be configured with a piezoelectric element.

### Circulation Module 12

The circulation module 12 includes a circulation heater RhB, a circulation driver element MD2, and a circulation logic circuit AND2. The circulation heater RhB is configured with, for example, an electrothermal conversion element. The circulation heater RhB is in the state where the voltage is applied from the power supply voltage VH to the circulation heater RhB, and a current flows through the circulation heater RhB if the circulation driver element MD2 is in a conduction state. The circulation driver element MD2 is configured with, for example, a MOSFET (Metal-Oxide-Semiconductor Field Effect Transistor). Note that the circulation driver element MD2 may be configured with a component other than a MOSFET. For example, the circulation driver element MD2 may be configured with a bipolar transistor. Alternatively, the circulation driver element MD2 may be configured with an IGBT (Insulated Gate Bipolar Transistor). The circulation logic circuit AND2 selectively drives the circulation driver element MD2. The enable signal HE, the circulation group selection signal, and the circulation time-division selection signal are inputted into the input side of the circulation logic circuit AND2. The enable signal HE is transmitted from the controller 202. The enable signal HE controls a current pulse width of the circulation driver element MD2, that is, a time during which the conduction state is established between the drain and the source of the circulation driver element MD2 to allow the current to continuously flow between the drain and the source of the circulation driver element MD2. The enable signal HE is a signal for adjusting the current pulse width so that a more desirable thermal energy can be generated in consideration of various manufacturing variations. The various manufacturing variations include, for example, a manufacturing variation of resistance values of the circulation heaters RhB mounted in the ejection element board 101, and a manufacturing variation of the power supply circuit 203. In addition, the various manufacturing variations also include a voltage drop of the power supply-side wiring in the case of simultaneously driving a plurality of heaters such as the circulation heater RhB and the ejection heater RhA. Note that the enable signal HE may be transmitted from the controller 202 via an external input terminal provided on the ejection element board 101, which is not shown. The circulation group selection signal is supplied from the circulation group selection signal wiring 20. The circulation time-division selection signal is supplied from the circulation time-division selection signal wiring 33. The output side of the circulation logic circuit AND2 is connected to the gate of the circulation driver element MD2. Hence, the circulation driver element MD2 is configured such that if all the signals inputted from the input side of the circulation logic circuit AND2 are 1, the voltage is applied to the gate of the circulation driver element MD2, so that the conduction state is established between the drain and the source of the circulation driver element MD2. If the conduction state has been established between the drain and the source of the circulation driver element MD2, the current flows through the circulation heater RhB, so that heat is generated in the circulation heater RhB. By this series of operations, the bubbles of the ink grow, making it possible to generate a circulation flow in the circulation flow passage for the ink. Note that although an example in which the circulation heater RhB is configured with an electrothermal conversion element has been described, the circulation heater RhB is not particularly limited to this. For example, the circulation heater RhB may be configured with a piezoelectric element.

Note that regarding the above-described enable signal HE, one enable signal HE is shared for ejection and circulation in order to reduce the number of signal terminals. Hence, the current pulse width cannot be controlled individually for ejection and circulation. In view of this, the current pulse width may be adjusted with one enable signal HE on the assumption that the ejection heater RhA and the circulation heater RhB are manufactured in accordance with the same step of a semiconductor manufacturing process to be finished with the same manufacturing variation (an amount of deviation in resistance value from an ideal value).

### Control Data Supply Circuit 31

The control data supply circuit 31 includes shift registers 13a, 13b, and 13c, latch circuits 14a, 14b, and 14c, a circulation decoder circuit 32, a decoder circuit 15, and a circulation group control circuit 16. In addition, the control data supply circuit 31 is provided with external input terminals. The control data supply circuit 31 is supplied with a clock signal CLK, a data signal DATA, and a latch signal LT from the controller 202 via the external input terminals. The clock signal CLK is a signal to be used in the case of serial-data transfer of the data signal DATA to the shift registers 13c, 13a, and 13b. The data signal DATA contains selection information on the ejection modules 11 and selection information on the circulation modules 12. The latch signal LT obtains and holds information stored in each of the shift registers 13c, 13a, and 13b in each latch cycle. The details of the circulation decoder circuit 32, the decoder circuit 15, and the circulation group control circuit 16 will be described later.

### Drive Control of Ejection Heater RhA

A drive control of the ejection heaters RhA based on an ejection heater array 21 will be described. The ejection heater array 21 is configured with m groups. Each group includes n ejection heaters RhA. The ejection heaters RhA are disposed directly below the ejection orifices for the ink. In the case where one group is selected, each of the n ejection heaters RhA in the one group is sequentially executed in a time-division manner. Ejection heater arrays are arranged side by side in a length of 1 inch at an arrangement density of 600 dpi, and the drive control of (n=16)×(m=40 groups) ejection heaters RhA will be described.

### Time-Division Control in One Group

As mentioned above, the ejection heaters RhA are included in the respective ejection modules 11. In addition, one group includes n ejection heaters RhA. Hence, one group includes n ejection modules 11. In addition, since it is assumed that n=16, 16 ejection modules 11 are driven by the ejection time-division selection signals in a time-division drive. The time-division drive is a control of dividing a certain ejection cycle time into n=16 time units, and sequentially selecting the ejection modules 11 one by one for each divided time unit. Here, a plurality of the ejection modules 11 are not selected simultaneously in the same group. Each of all the ejection modules 11 included in the same group is selected surely at least once in one ejection cycle. In such a time-division drive, the ejection time-division selection signal wiring 18 is brought into a state where any one wiring only is selected. Hence, by providing the decoder circuit 15 in the control data supply circuit 31, it becomes possible to further reduce the data amount of serial transfer from the main board 201.

### Decoder Circuit 15; Time-division Control

The decoder circuit 15 is a circuit which expands, relative to the number of bits q of input data, the number of bits of output data to 2 raised to the power of q. Specifically, if input data of 4 bits is inputted into the decoder circuit 15, the decoder circuit 15 converts the input data of 4 bits to output data of 2 raised to the power of 4=16 bits. In this case, the output data of the decoder circuit 15 is outputted as such information that only 1 bit is valid among 16 bits. This enables the time-division drive. Here, as the ejection time-division selection signal wiring 18 to be outputted from the decoder circuit 15, it is more preferable to use all the wirings for ejection time-division selection signals in terms of use efficiency of input data as long as there is no special usage. Note that as the data amount of serial transfer increases, serial transfer of higher speed is required. Hence, in the main board 201 and the ejection element board 101, it is preferable to reduce the data amount as much as possible because this leads to a cost up and a size up of a signal transmission circuit, a signal reception circuit, and a transmission line.

### Selection Control of Group

In order to selectively drive any one of the m groups, an ejection group selection signal of m bits is outputted from the control data supply circuit 31. In the case of selecting one group among the m groups, it is possible to simultaneously select n ejection modules 11 included in the one group. Information of m bits which is the same as the number of groups is serially transferred from the main board 201. As mentioned above, the enable signal HE, the ejection group selection signal, and the ejection time-division selection signal are inputted into the ejection logic circuit AND1, so that the ejection modules 11 are selectively controlled such that the current flows through the corresponding ejection heater RhA. Note that an example in which it is assumed that n=16 and m=40 is described in the present embodiment, the configuration is not particularly limited to this. For example, a configuration in which n=8 and m=80 may be employed. Alternatively, for example, a different nozzle length n=32 and m=40 or the like from those of the present embodiment may be employed. However, since n is a time-division number, it is preferable that n is corporated by an expression of 2 to the power of n which is for example 2, 4, 8, 16, 32 so that output signal of the decoder circuit 15 can be utilized as a selection signal.

### Drive Control of Circulation Module 12

A drive control of the circulation heaters RhB based on a circulation heater array 22 will be described. The circulation heater array 22 is configured with m groups in the same manner as in the ejection heater array 21. Each group includes n circulation heaters RhB in the same manner as in the ejection heater array 21. The circulation heaters RhB are arranged to be close to the ejection heaters RhA in one-to-one correspondence. In the case where one group is selected, each of the n circulation heaters RhB in the one group is sequentially executed in a time-division manner. The drive control of (n=16)×(m=40 groups) circulation heaters RhB will be described.

### Time-division Control in One Group

As mentioned above, the circulation heater RhB is included in each circulation module 12. In addition, one group includes n circulation heaters RhB. Hence, one group includes n circulation modules 12. In addition, since it is assumed that n=16, 16 circulation modules 12 are driven by circulation time-division selection signals in a time-division drive at a time-division number different from the ejection modules 11. In the present embodiment, the time-division number of the circulation modules 12 is 32 which is twice the n=16 of the time-division number of the ejection modules 11. For the circulation time-division selection signal, the circulation decoder circuit 32 is included in the control data supply circuit 31 in order to reduce the data amount serially transferred from the main board 201.

### Circulation Decoder Circuit 32; Time-division Control

The circulation decoder circuit 32 is a circuit which expands, relative to the number of bits q of input data, the number of bits of output data to 2 raised to the power of q. Specifically, if input data of 5 bits is inputted into the circulation decoder circuit 32, the circulation decoder circuit 32 converts the input data of 5 bits to output data of 2 raised to the power of 5=32 bits. In this case, the output data of the circulation decoder circuit 32 is outputted as such information that only 1 bit is valid among 32 bits. This enables the time-division drive. Here, the circulation heaters RhB are configured with (n=16)×(m=40 groups). Hence, 16 bits, that is, half of the circulation time-division selection signal whose number of bits of output data is 32, are used as selection signals for the circulation modules 12, and the remaining 16 bits are not connected to any circuit and are unused. That is, among 32 bits, 16 bits of the half are used for time-division, and the remaining 16 bits are used not for time-division but as a delay slot. In addition, while the ejection modules 11 take one round by the time-division drive, the circulation modules 12 are also driven by the time-division drive. While the ejection modules 11 take two rounds by the time-division drive, the circulation modules 12 are not selected. In this way, while the time-division drive of the circulation modules 12 takes one round, the time-division drive of the ejection modules 11 takes two rounds. Note that although in the above-described example, an example in which among 32 bits, 16 bits are used for time-division, and the remaining 16 bits are used as a delay slot has been described, the configuration is not particularly limited to this. For example, among 32 bits, 20 bits may be used for time-division while the remaining 12 bits are used as a delay slot. That is, the ejection drive frequency and the circulation drive frequency only have to be made different from each other. Specifically, the time-division number of the circulation time-division selection signals may be set to be larger than the time-division number of the ejection time-division selection signals. As an example of this, in the first use case, processing of lowering the circulation drive frequency as compared with the ejection drive frequency has been described.

### Selection Control of Group

In order to selectively drive any one of the m groups, the circulation group selection signal of m bits is outputted from the control data supply circuit 31. In the case of selecting one group among the m groups, it is possible to simultaneously select n circulation modules 12 included in the one group. Information of m bits which is the same as the number of groups is serially transferred from the main board 201. As mentioned above, the enable signal HE, the circulation group selection signal, and the circulation time-division selection signal are inputted into the circulation logic circuit AND2, so that the circulation module 12 is selectively controlled such that the current flows through the corresponding circulation heater RhB. However, the circulation group selection signal is transferred from the circulation group control circuit 16 via the circulation group selection signal wiring 20. The circulation group control circuit 16 is included in the control data supply circuit 31.

### Circulation Group Control Circuit 16

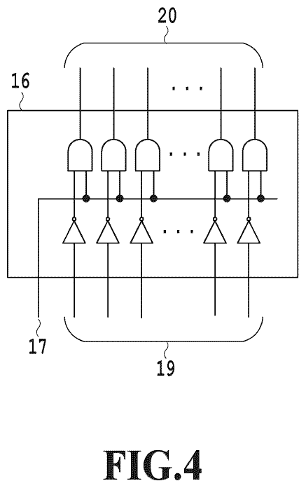

The circulation group control circuit 16 generates the circulation group selection signal in accordance with selection information of the ejection group selection signal. FIG. 4 is a diagram showing an example of a circuit configuration of the circulation group control circuit 16 of FIG. 3. The circulation group control circuit 16 includes NOT circuits and AND circuits. A result of logical AND of a signal obtained by logically inverting an ejection group selection signal, which is obtained from the ejection group selection signal wiring 19, by the NOT circuit and a circulation flag signal, which is obtained from the circulation flag signal wiring 17 is processed as follows. Specifically, the result of the logical AND is outputted to the circulation group selection signal wiring 20 as the circulation group selection signal. Hence, in the case where the ejection module 11 is in a selection state, the circulation module 12 is in a non-selection state. On the other hand, in the case where the ejection module 11 is in a non-selection state and the circulation flag signal is High, the circulation module 12 is in a selection state. That is, the pair of ejection module 11 and circulation module 12 are selected exclusively from each other. Note that while the time-division selection is not conducted, both of the ejection module 11 and the circulation module 12 are not selected.

### Timing Chart

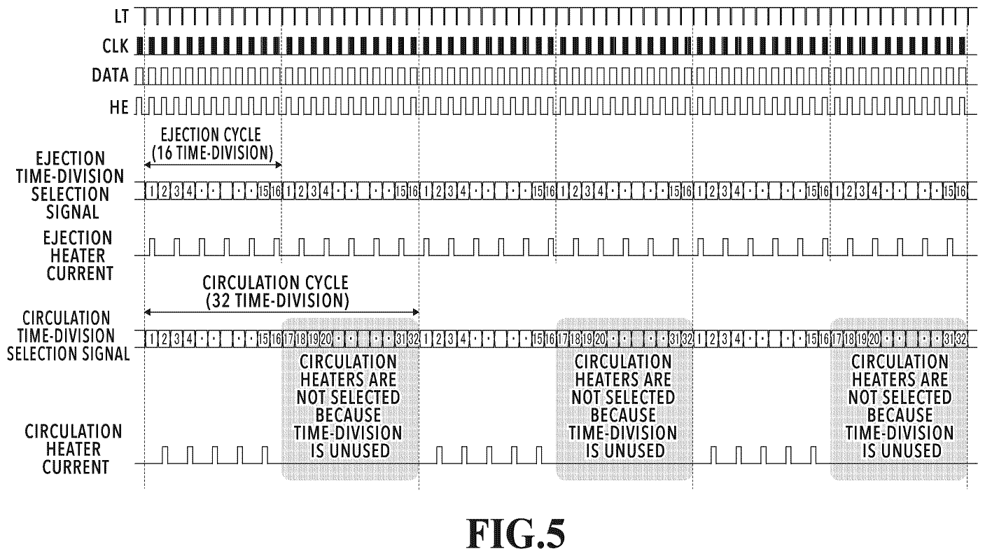

FIG. 5 is a timing chart of the ejection element board 101 of FIG. 3. The clock signal CLK, the data signal DATA, the latch signal LT, and the enable signal HE are inputted from the main board 201 into the ejection element board 101. The ejection time-division selection signal is time-divided into 1 to 16 for every latch cycle, so that the ejection driver elements MD1 are sequentially driven to cause the current to flow through the corresponding ejection heaters RhA. Similarly, the circulation time-division selection signal is time-divided into 1 to 32 for every latch cycle, so that the circulation driver elements MD2 are sequentially driven. Since 16 bits of the circulation time-division selection signal are used as selection signals for the circulation module 112 as mentioned above, the current flows through the corresponding circulation heaters RhB during the time units 1 to 16 of the time division as shown in FIG. 5. However, regarding the time units 17 to 32 of the time division, which correspond to the remaining unused 16 bits among the circulation time-division selection signal, the corresponding circulation heaters RhB are not selected. That is, it is assumed that the ejection operation is conducted at an ejection frequency of, for example, 30 kHz while the time-division drive of the ejection heater array 21 takes one round over an ejection cycle. According to this assumption, since the time-division number of the circulation heater array 22 is set to be twice that of the ejection heater array 21, it is possible to conduct the ink circulation operation at 15 kHz, which is ½ of the ejection frequency. Although in the present embodiment, 1 to 16 among the circulation time-division selection signal are used, another combination may be employed. For example, the even bits may be used while the odd bits are not used. In addition, the ink circulation operation may further be set to ¼ or ⅛ of the ejection frequency by setting the time-division number of the circulation heater array 22 to 4 times or 8 times that of the ejection heater array 21. There is a situation in which the ejection drive frequency and the optimal frequency band in the ink circulation operation are different. By using the circulation time-division selection signal of the circulation heater array 22 as in the present embodiment, it becomes possible to drive the circulation heater array 22 in such a manner as to obtain an optimal drive frequency as the ink circulation operation irrespective of the drive frequency of the ejection heater array 21. In addition, in the present embodiment, the circulation flag signal for determining whether the circulation group selection signal can be made valid is further provided. By making the circulation flag signal invalid, the selection of the circulation modules 12 is inhibited at the time of normal ejection operation which does not require the ink circulation. A system in which the circulation flag signal is serially transferred from the main board 201 is preferable.

In the present embodiment, the common power supply voltage VH (for example, 24 V) is connected as the power supply voltages and the common GNDH is connected as the ground potential, for the ejection modules 11 and the circulation modules 12. However, in the case where it is desirable to further reduce fluctuations in ejection energy due to a voltage drop in the case of driving the ejection heaters RhA and the circulation heaters RhB, the following measure is possible. Specifically, supply wirings and external connection terminals for the power supply voltage and the ground potential may be provided inside the ejection element board 101 individually for the ejection modules 11 and the circulation modules 12. That is, a configuration of supplying the power supply voltage and the ground potential individually from the power supply circuit 203 mounted in the main board 201 may be employed.

In general, since a driver element is operated at a higher voltage than that of a logic circuit, a board including both a high-voltage-tolerant driver element and a normal driver element together is used. In the present embodiment, the ejection driver element MD1 and the circulation driver element MD2 may be configured with DMOS transistors (Double-diffused MOSFETs), which are high-voltage-tolerant MOS transistors. Logic circuits such as the ejection logic circuit AND1 and the circulation logic circuit AND2, the circulation group control circuit 16, as well as the other shift registers 13a, 13b, and 13c, latch circuits 14a, 14b, and 14c, and decoder circuit 15 may be configured with low-voltage-tolerant MOS transistors.

### Second Use Case

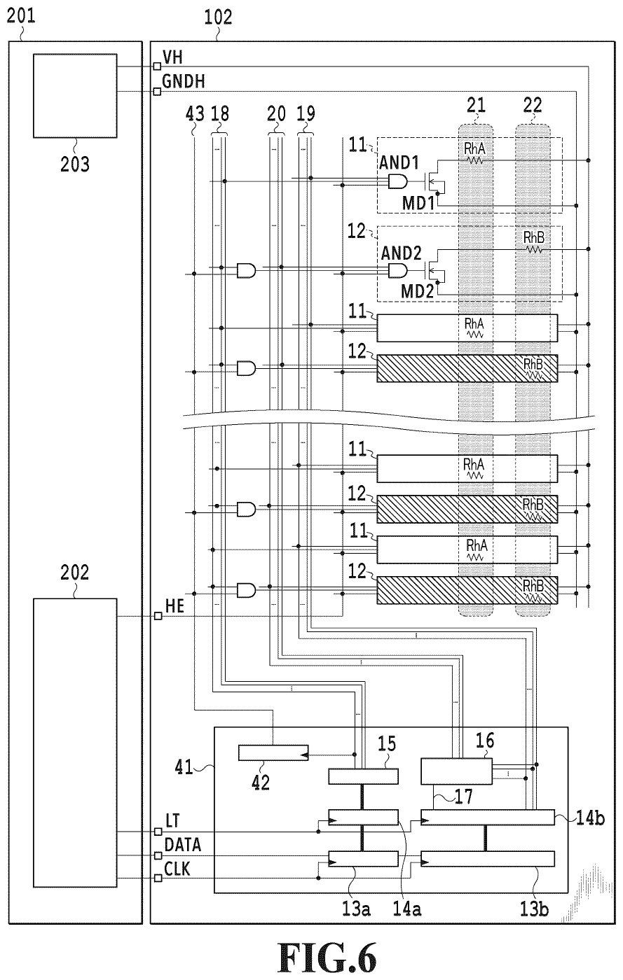

FIG. 6 is a diagram showing an example of a circuit configuration of an ejection element board 102 of a second use case. In the second use case, the description of the same configurations and functions as those in the first use case will be omitted. The second use case is different from the first use case in the following points. Specifically, the second use case is different from the first use case in that the circulation decoder circuit 32, the latch circuit 14c, and the shift register 13c are removed from the control data supply circuit 41, an ejection cycle counter circuit 42 is newly added, and along with this, a time-division frequency-division signal wiring is added.

The control data supply circuit 41 includes the ejection cycle counter circuit 42. The ejection cycle counter circuit 42 is configured with, for example, a toggle circuit using a flip-flop. The ejection cycle counter circuit 42 obtains an ejection time-division selection signal from the ejection time-division selection signal wiring 18. The ejection cycle counter circuit 42 outputs, to the time-division frequency-division signal wiring 43, signals generated by alternately repeating “High” and “Low” in an output logic of the obtained ejection time-division selection signals, for every 1 cycle of a time-division drive of the ejection heaters RhA. The logical AND of the time-division frequency-division signal wiring 43 and the ejection time-division selection signal wiring 18 is inputted into the circulation logic circuits AND2. In this way, the output logic of the circulation logic circuits AND2 is set to “Low” for every other cycle of the time-division drive of the ejection heaters RhA, and the circulation driver elements MD2 are brought into a non-conduction state. Hence, the current is prevented from flowing through the circulation heaters RhB for every other cycle of the time-division drive of the ejection heaters RhA. That is, while the time-division drive of the circulation modules 12 takes one round, the time-division drive of the ejection modules 11 takes two rounds, as in the case of the use case 1.

### Timing Chart

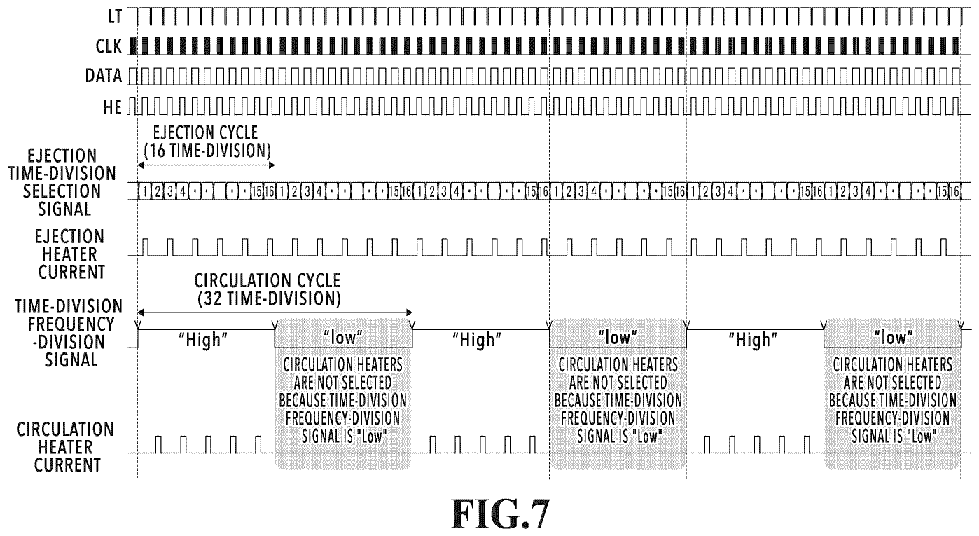

FIG. 7 is a timing chart of the ejection element board of FIG. 6. A clock signal CLK, a data signal DATA, a latch signal LT, and an enable signal HE are inputted from a main board 201 into an ejection element board 101. The ejection time-division selection signal is time-divided into 1 to 16 for every latch cycle, so that the ejection driver elements MD1 are sequentially driven to cause the current to flow through the corresponding ejection heaters RhA. In the present embodiment, the logic of the time-division frequency-division signal, which is an output signal, repeats outputs of “High” and “Low” every time the 16th rising edge in the time division in the ejection time-division selection signal is inputted into the ejection cycle counter circuit 42. Note that the ejection time-division selection signal may be selected from 1 to 16 in a random order. As mentioned above, in the circulation module 12, in the case where the time-division frequency-division signal is “High”, the ejection time-division selection signal becomes valid, so that the current flows through the corresponding circulation heater RhB between the time units 1 to 16 of the ejection time-division as shown in FIG. 7. However, since the logic of the time-division frequency-division signal is “Low” between the time units 1 to 16 of the ejection time-division in the next cycle, the corresponding circulation heater RhB is not selected. Hence, it is possible to conduct the ink circulation operation with the same advantageous effect as that in the first use case, that is, at a frequency of ½ of the ejection frequency, while further suppressing an increase in the areas of the circuits and wirings as compared with the first use case. In addition, it is also possible to conduct the ink circulation operation at ¼ or ⅛ of the ejection frequency by processing the cycle of switching the output logic of the time-division frequency-division signal to every 4 cycles or every 8 cycles relative to the ejection time-division selection signal. The cycle of switching the output logic of the time-division frequency-division signal may be determined at the time of designing masks of the ejection element board 102, but may be configured to be serially transferred together with ejection heater selection information from the main board 201 so that the cycle can be freely changed in accordance with the physical properties of the inks to be used. Note that although an example in which the ejection cycle counter circuit 42 is configured with a toggle circuit has been described, the configuration is not particularly limited to this. For example, the ejection cycle counter circuit 42 may be configured not with a toggle circuit but with a counter circuit. According to such a circuit configuration, for example, it is also possible to process the cycle of switching the output logic of the time-division frequency-division signal to every 3 cycles, every 4 cycles, or every 5 cycles, for the ejection time-division selection signal. In short, the ejection drive frequency and the circulation drive frequency only have to be made different from each other. As an example of this, in the second use case, the processing of lowering the circulation cycle as compared with the ejection cycle has been described. For example, it is assumed that one cycle of the ejection cycle is defined as one unit, and the circulation cycle is lowered. Under such assumption, for example, the following operation may be conducted in order to lower the circulation cycle to 3 cycles. Specifically, a configuration may be employed in which the circulation cycle is set to “High” at the first cycle of the ejection cycle, and the circulation cycle is set to “Low” at the second cycle and the third cycle of the ejection cycle, and the circulation cycle is set to “High” at the fourth cycle of the ejection cycle after one cycle. In short, it is also possible to process the cycle of switching the output logic of the time-division frequency-division signal for every predetermined cycle for the ejection time-division selection signal.

### Third Use Case

The case where the ejection frequency is low will be described. For example, in the case of driving the circulation operation at 15 kHz relative to 7.5 kHz of the ejection frequency, the following configuration may be employed. Specifically, it is assumed that the ejection time-division selection signal is set to 32 bits, and 1 to 16 bits are used for selection of the ejection heaters RhA, and 17 to 32 bits are not used, among the 32 bits. Upon this assumption, the circulation time-division selection signal is set to 16 bits, and the operation is conducted such that the circulation time-division takes two rounds while the ejection time-division takes one round. According to such an operation, it is also possible to make the frequency of the circulation operation twice the ejection frequency.

That is, as mentioned above, the same numbers of the ejection modules 11 and the circulation modules 12 are provided. Under this configuration, the control data supply circuit 31 may be configured such that the time-division number of the ejection time-division selection signal to drive the ejection driver elements MD1 in a time-division manner is set to twice or more the time-division number of the circulation time-division selection signal to drive the circulation driver elements MD2 in a time-division manner. Note that in the above-described example, an example in which among 32 bits, 16 bits are used for time-division, and the remaining 16 bits are used for a delay slot has been described, the configuration is not particularly limited to this. For example, among 32 bits, 20 bits are used for time-division while the remaining 12 bits are used for a delay slot. In short, the ejection drive frequency and the circulation drive frequency only have to be made different from each other. Specifically, the time-division number of the ejection time-division selection signal may be set to be larger than the time-division number of the circulation time-division selection signal. As an example of this, in the third use case, the processing of lowering the ejection drive frequency as compared with the circulation drive frequency has been described.

### Circuit Area

The drive current of the circulation heaters RhB generates a thermal energy for circulating the inks inside individual flow passages. In the case where the drive current of the circulation heaters RhB is smaller than the drive current of the ejection heaters RhA for ejecting the inks onto the ejection-target medium, the current-drive capability of the DMOS transistors may be small. Hence, since there is no need to make the area of the circulation driver elements MD2 larger than the area of the ejection driver elements MD1, a configuration in which the area of the circulation driver elements MD2 is smaller than the area of the ejection driver elements MD1 is more preferable.

### First Case of Circuit Arrangement

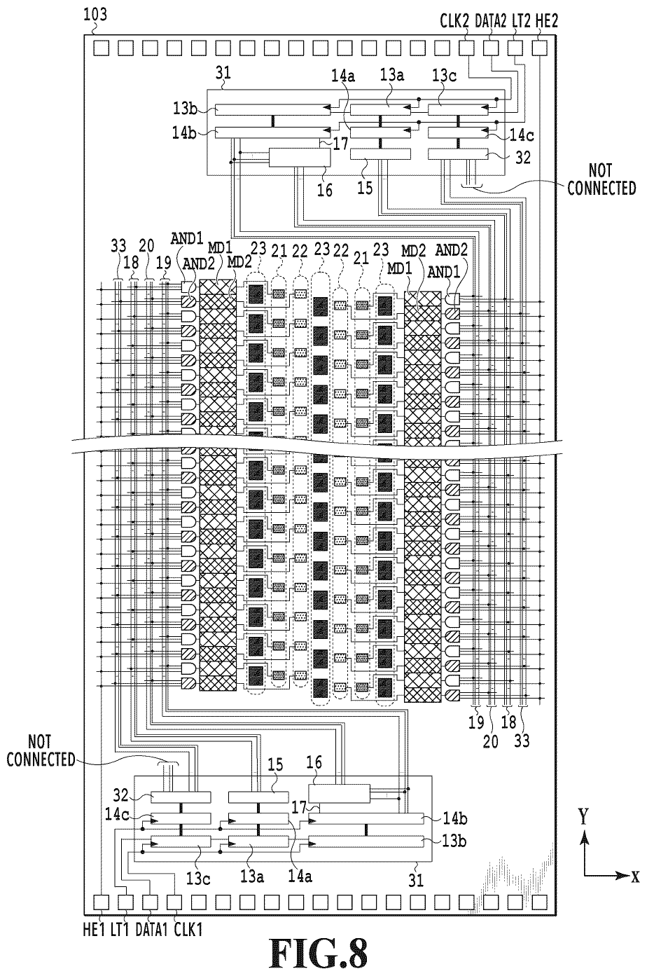

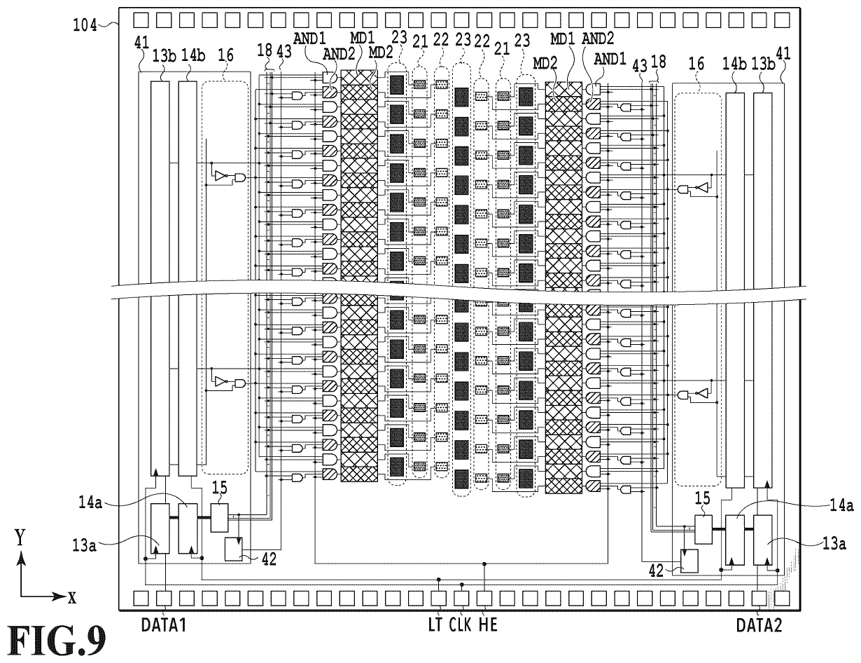

FIG. 8 is a plan view of an ejection element board 103. In the example of FIG. 8, two mechanisms for selection control are arranged in two systems which are point-symmetrical about the center of the ejection element board 103 from a control data supply circuit 31 across ejection heater arrays 21 and circulation heater arrays 22. In FIG. 8, in the conveyance direction Y, three ink supply port arrays 23 are arranged at intervals along the direction X. Note that in the following FIGS. 9 to 11, the conveyance direction Y and the direction X are defined in the same manner. That is, the direction X is defined in the lateral direction of the sheet surface, and the conveyance direction Y is defined in the longitudinal direction of the sheet surface. Between each two of the ink supply port arrays 23, the ejection heater array 21 and the circulation heater array 22 are each arranged in one array along the conveyance direction Y. In each of a region on the left side of the left ink supply port array 23 and a region on the right side of the right ink supply port array 23, among the three ink supply port arrays 23, the followings are arrayed. Specifically, ejection driver elements MD1, circulation driver elements MD2, ejection logic circuits AND1, circulation logic circuits AND2, an ejection group selection signal wiring 19, a circulation group selection signal wiring 20, an ejection time-division selection signal wiring 18, and a circulation time-division selection signal wiring 33 are arrayed.

In the upper and lower two board end portions in the conveyance direction Y on the ejection element board 103, external connection terminals are arrayed along the direction X. In a region between the external connection terminals and the ink supply port array 23, a control data supply circuit 31 is disposed. Since the region between the external connection terminals and the ink supply port array 23 is present in the upper and lower two portions in the conveyance direction Y, the control data supply circuits 31 are also disposed in upper and lower two portions in the conveyance direction Y.

As described above, as shown in FIG. 8, the ejection element board 103 is configured to be disposed in the conveyance direction Y, it is possible to reduce the board dimension of the ejection element board 103 in the direction X. In addition, although not shown in the drawing, in the case where the arrangement configuration of the ejection element board 103 is assumed to be one unit, it is also possible to obtain a configuration in which a plurality of ink types are provided in one ejection element board 103 by arranging a plurality of the arrangement configurations of the ejection element boards 103 side by side in the direction X.

### Second Case of Circuit Arrangement

FIG. 9 is a plan view of an ejection element board 104. On the ejection element board 104 of FIG. 9, circulation time-division selection signal wirings 33 are not disposed as compared with the ejection element board 103 of FIG. 8. Hence, control data supply circuits 41 are disposed left and right two end portions in the direction X on the ejection element board 104. Although the board dimension in the direction X is slightly larger than that in the example of FIG. 8, the ejection element board 104 of FIG. 9 can be disposed in a smaller board dimension in the conveyance direction Y. The area of the ejection element board can also be made smaller than that in First Case of Circuit Arrangement.

### Third Case of Circuit Arrangement

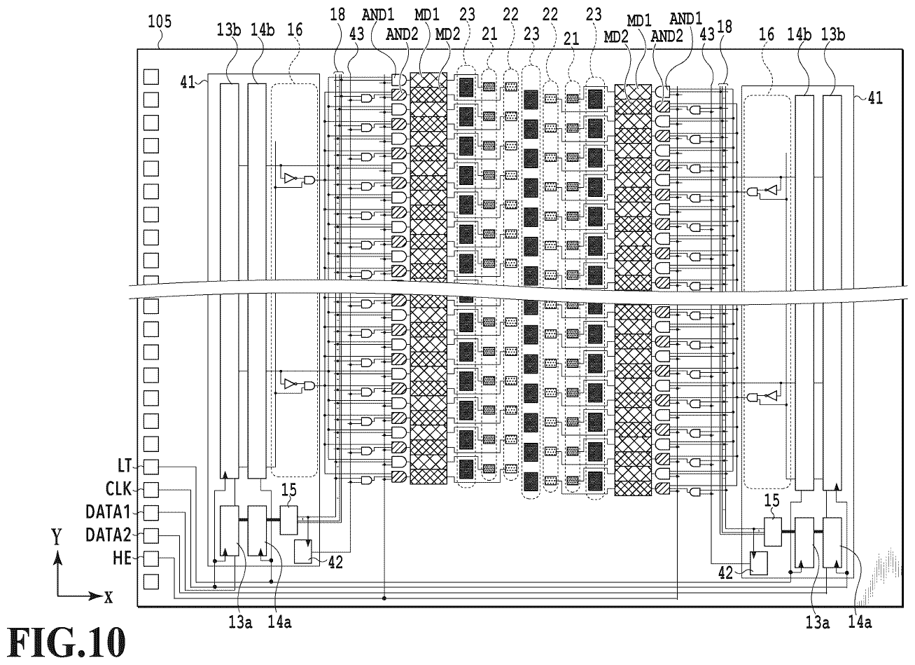

FIG. 10 is a plan view of an ejection element board 105. On the ejection element board 105 of FIG. 10, external connection terminals are disposed on the left side in the direction X as compared with the ejection element board 104 of FIG. 9. It is possible to reduce the board dimension in the conveyance direction Y as compared with the ejection element board 104. Although not shown in the drawing, the wiring configuration of the ejection element board 105 is assumed to be one unit. On this assumption, in the case where a plurality of the ejection element boards 105 are mounted along an arrangement direction of ink supply port arrays 23, it is possible to reduce the space between the ejection element boards 105 more in the present configuration in which external connection terminals are not provided on extension lines of the ink supply port arrays 23. Hence, it is also possible to reduce the size of the liquid ejection head.

### Fourth Case of Circuit Arrangement

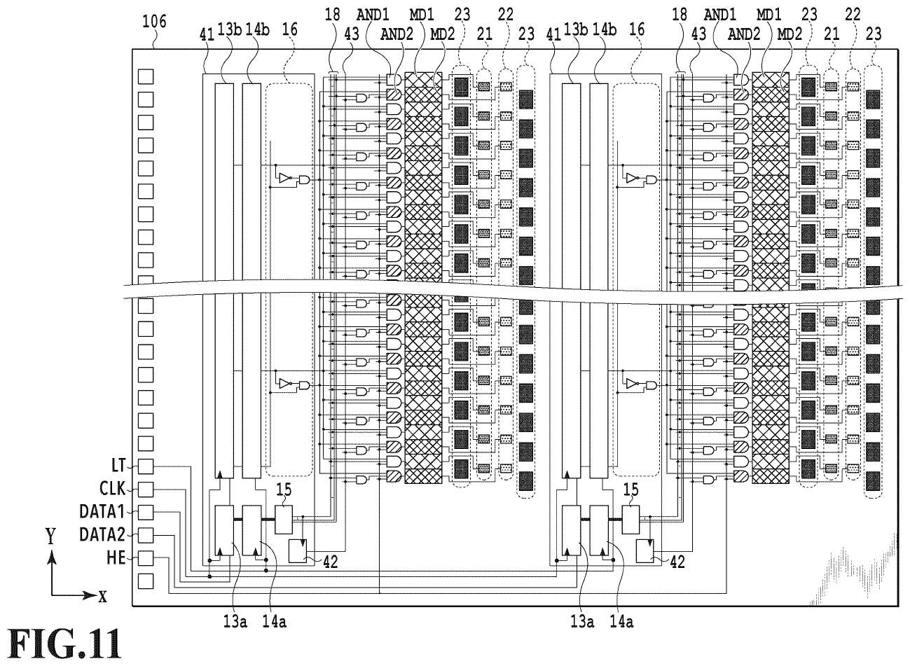

FIG. 11 is a plan view of an ejection element board 106. In FIG. 11, units each including a control data supply circuit 41, an ink supply port array 23, an ejection heater array 21, a circulation heater array 22, an ink supply port array 23, and the like are arranged side by side in the direction X. This arrangement is a configuration in which the distance between the ink supply port arrays 23 is separated in each unit on the assumption of supplying different ink types to the ink supply port arrays 23 in the ejection element board 106. This configuration makes it possible to avoid mixing of inks of different ink types at the time of ejection.

### Other Embodiments

Although the present disclosure has been described by showing various examples and embodiments so far, the gist and scope of the present disclosure are not limited to the specific descriptions of the present Specification. The present disclosure is not limited to the above-mentioned embodiments, and various modifications may be made. In addition, in the present disclosure, parts of the above-mentioned embodiments may be combined as appropriate.

### Modification 1

For example, although in the present embodiments, the example in which each time interval of the conduction state and the non-conduction state of the ejection driver elements MD1 and the circulation driver elements MD2 is uniformly time-divided has been described, the configuration is not particularly limited to this. For example, the time interval of the conduction state of the ejection driver elements MD1 and the circulation driver elements MD2 and the time interval of the non-conduction state of the ejection driver elements MD1 and the circulation driver elements MD2 may be made different from each other.

### Modification 2

In addition, for example, although in the present embodiments, the example in which the ejection driver elements MD1 and the circulation driver elements MD2 are each configured with a DMOS transistor has been described, the configuration is not particularly limited to this. For example, at least either the ejection driver elements MD1 or the circulation driver elements MD2 may be configured with SiC (Silicon Carbide) MOSFETs.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

The present disclosure makes it possible to drive a circulation driver element at an optimal drive frequency.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159087, filed Sep. 13, 2024 which is hereby incorporated by reference herein in its entirety.

What is claimed is:

1. A liquid ejection head comprising:
an ejection module which includes an ejection driver element and an ejection heater capable of being electrically connected to the ejection driver element;
a circulation module which is arranged in a pair with the ejection module, and which includes a circulation driver element and a circulation heater capable of being electrically connected to the circulation driver element; and
a control unit which controls each of the ejection driver element and the circulation driver element into any one of a conduction state and a non-conduction state, wherein
the control unit makes an ejection drive frequency utilized to drive the ejection driver element and a circulation drive frequency utilized to drive the circulation driver element different from each other.

2. The liquid ejection head according to claim 1, wherein
the same numbers of the ejection modules and the circulation modules are provided, and
the control unit sets a time-division number of a circulation time-division selection signal for driving the circulation driver elements in a time-division manner to be larger than a time-division number of an ejection time-division selection signal for driving the ejection driver elements in a time-division manner.

3. The liquid ejection head according to claim 2, further comprising:
a decoder circuit which expands the number of output bits of output data as the time-division number of the ejection driver elements to 2 raised to the power of the number of input bits in response to the number of input bits of input data; and
a circulation decoder circuit which expands the number of output bits of output data as the time-division number of the circulation driver elements to 2 raised to the power of a number which being added 1 to the number of input bits in response to the number of input bits of input data.

4. The liquid ejection head according to claim 2, wherein,
the control unit drives in a time-division manner the ejection driver elements in ejection groups each of which is divided into a predetermined number of the plurality of the ejection modules, and
the control unit drives in a time-division manner the circulation driver elements in circulation groups each of which is divided into the predetermined number of the plurality of the circulation modules.

5. The liquid ejection head according to claim 4, wherein the control unit selects the circulation groups exclusively from the ejection groups.

6. The liquid ejection head according to claim 2, further comprising an ejection cycle counter circuit which makes a time-division drive of the circulation driver elements stop for every predetermined cycle of a time-division drive of the ejection heaters by the ejection driver elements based on the ejection time-division selection signal.

7. The liquid ejection head according to claim 1, wherein
the same numbers of the ejection modules and the circulation modules are provided, and
the control unit sets a time-division number of an ejection time-division selection signal for driving the ejection driver elements in a time-division manner to be larger than a time-division number of a circulation time-division selection signal for driving the circulation driver elements in a time-division manner.

8. The liquid ejection head according to claim 1, wherein a common power supply voltage and a common ground potential are connected to the ejection heater and the circulation heater.

9. The liquid ejection head according to claim 1, wherein the ejection heater and the circulation heater are formed by the same semiconductor step.

10. The liquid ejection head according to claim 1, wherein the ejection heater and the circulation heater are formed of the same material.

11. A liquid ejection apparatus comprising:
a liquid ejection head;
a carriage on which the liquid ejection head is mounted, and which reciprocates the carriage being configured to reciprocate in a main scanning direction; and
a conveyance roller which is provided below the carriage, and which conveys an ejection-target medium in a sub scanning direction, wherein
the liquid ejection head includes:
an ejection module which includes an ejection driver element and an ejection heater capable of being electrically connected to the ejection driver element;
a circulation module which is arranged in a pair with the ejection module, and which includes a circulation driver element and a circulation heater capable of being electrically connected to the circulation driver element; and
a control unit which controls each of the ejection driver element and the circulation driver element into any one of a conduction state and a non-conduction state, wherein
the control unit makes an ejection drive frequency utilized to drive the ejection driver element and a circulation drive frequency utilized to drive the circulation driver element different from each other.
